(19) United States
(12) Patent Application Publication
(10) Pub. No.: US 2026/0243186 A1
(43) Pub. Date: Aug. 20, 2026

(54) ENGINE SYSTEM HAVING RECUPERATED CATALYST IN EXHAUST SYSTEM AND METHOD

(71) Applicant: Caterpillar Inc., Peoria, IL (US)

(72) Inventors: David Todd Montgomery, Edelstein, IL (US); Daniel Bryan Olsen, Fort Collins, CO (US)

(73) Assignee: Caterpillar Inc., Peoria, IL (US)

(21) Appl. No.: 19/058,098

(22) Filed: Feb. 20, 2025

(51) Int. Cl. F01N 3/20; B01D 53/94; F01N 3/10; F01N 3/30; F01N 3/36; F01N 3/38; F01N 5/02

(52) U.S. Cl. CPC F01N 3/2033; B01D 53/945; F01N 3/103; F01N 3/306; F01N 3/36; F01N 3/38; F01N 5/02; B01D 2255/1023; B01D 2258/018; F01N 2570/12

(57) ABSTRACT

An engine system includes a reciprocating engine, and an exhaust system having a catalyst module, an exhaust heater, and an exhaust recuperator. The catalyst module receives a flow of incoming exhaust through the recuperator, and outputs a flow of outgoing exhaust through the recuperator to exchange heat with the flow of incoming exhaust. The exhaust heater may include a gaseous fuel burner and is arranged to input heat energy to at least one of the flow of incoming exhaust or the flow of outgoing exhaust to increase catalyst efficiency. The engine system may be a gaseous fuel engine system and the catalyst an oxidation catalyst to oxidize methane.

### TECHNICAL FIELD

The present disclosure relates generally to an engine system, and more particularly to a recuperated catalyst arrangement in an exhaust system for an engine.

### BACKGROUND

Internal combustion engines are well-known and widely used throughout the world for many purposes ranging from operating a driveline in a land vehicle or marine vessel, to powering pumps, compressors, and electrical generators. Engines operated on traditional hydrocarbon fuels produce a variety of undesired exhaust emissions. In the case of liquid fuels, such as diesel, engine exhaust typically contains particulate matter or soot, ash, and oxides of nitrogen or NOx. Gaseous fuel engines operating on, for example, natural gas tend to produce little or no soot and ash but do still tend to produce NOx and unburned hydrocarbons. In recent years, increased attention and engineering resources have been directed at limiting emissions of unburned hydrocarbons, and methane in particular.

Gaseous fuel engines operating on natural gas tend to experience so-called “methane slip” where uncombusted methane from a primary fuel supply passes through the engine without burning. Emissions of methane are perceived to be undesirable for a variety of reasons, and have been the subject of disincentives even through proposed legislation in some jurisdictions. A traditional strategy to reduce methane emissions has been to oxidize the methane in the exhaust stream to convert it into less undesirable compounds, typically water and carbon dioxide. While such strategies have been acceptable in the past, the bar continues to be set higher for virtually all emissions mitigation technologies, leaving ample room for improvement and development of alternative strategies. One method and system for thermal management in an exhaust system with aims at reducing certain emissions is set forth in U.S. Patent No. 8,061,123B2 to Driscoll et al.

### SUMMARY

In one aspect, an engine system includes an engine having an engine housing with a plurality of cylinders formed therein. The engine system further includes an exhaust system having a catalyst module, an exhaust heater, and an exhaust recuperator having a plurality of heat exchange surfaces. The catalyst module includes a module inlet arranged to receive a flow of incoming exhaust through the recuperator, and a module outlet arranged to feed a flow of outgoing exhaust through the recuperator to exchange heat with the flow of incoming exhaust via the plurality of heat exchange surfaces. The exhaust heater is arranged to input heat energy to at least one of the flow of incoming exhaust or the flow of outgoing exhaust.

In another aspect, an exhaust system for an engine includes a recuperator forming an exhaust conduit incoming segment and an exhaust conduit outgoing segment, and having a plurality of heat exchange surfaces. The exhaust system further includes a catalyst module having a module inlet arranged to receive a flow of incoming exhaust through the recuperator, and a module outlet arranged to feed a flow of outgoing exhaust through the recuperator to exchange heat with the flow of incoming exhaust via the plurality of heat exchange surfaces. The exhaust system further includes an exhaust heater arranged to input heat energy to at least one of the flow of incoming exhaust or the flow of outgoing exhaust.

In still another aspect, a method of operating an engine system includes combusting a fuel in a plurality of cylinders in an engine to produce exhaust, and feeding an incoming flow of exhaust through a recuperator to a catalyst. The method further includes feeding an outgoing flow of exhaust from the catalyst through the recuperator, and exchanging heat in the recuperator between the incoming flow of exhaust and the outgoing flow of exhaust. The method still further includes inputting additional heat energy to at least one of the incoming flow of exhaust or the outgoing flow of exhaust so as to increase a temperature of the incoming flow of exhaust fed to the catalyst.

### BRIEF DESCRIPTION OF DRAWINGS

FIG. 1 is a diagrammatic view of an internal combustion engine system, according to one embodiment;

FIG. 2 is a diagrammatic view of an exhaust system, according to one embodiment;

FIG. 3 is a diagrammatic view of an internal combustion engine system, according to one embodiment; and

FIG. 4 is a diagrammatic view of an internal combustion engine system, according to one embodiment.

### DETAILED DESCRIPTION

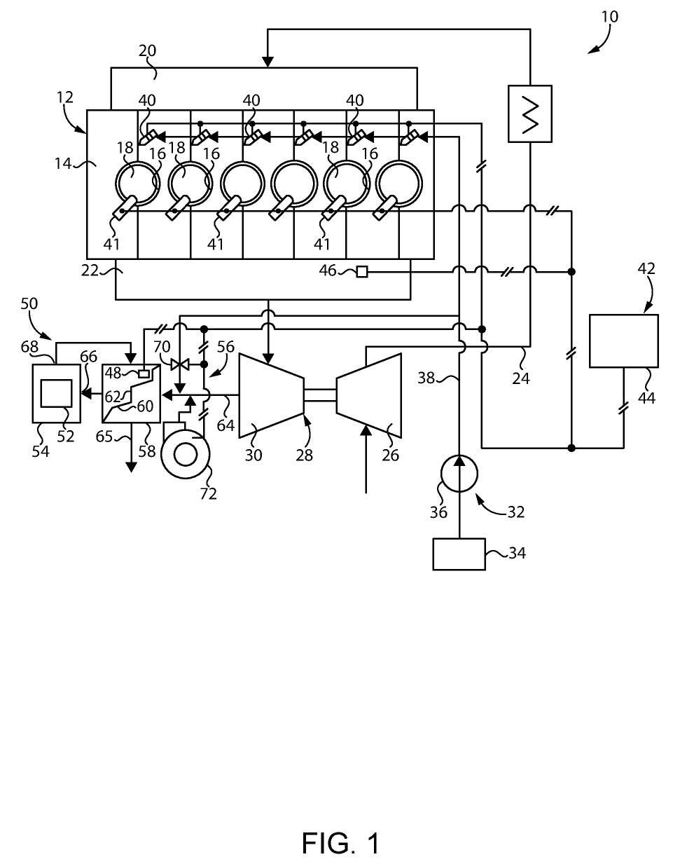

Referring to FIG. 1, there is shown an internal combustion engine system 10, according to one embodiment. Engine system 10 includes a reciprocating engine 12 having an engine housing 14. Engine housing 14 includes a plurality of cylinders 16 formed therein. A plurality of pistons 18 are positioned within respective cylinders 16 and movable therein between a top-dead-center position and a bottom-dead-center position in a generally conventional manner, typically in a four-stroke engine cycle. Cylinders 16 can include any number, in any suitable arrangement. Engine 12 further includes an intake manifold 20, and an exhaust manifold 22. An intake conduit 24 conveys a feed of pressurized intake air to intake manifold 20. The intake air is pressurized by way of a compressor 26 in a turbocharger 28. An exhaust conduit 64 conveys a feed of exhaust from exhaust manifold 22 typically through a turbine 30 of turbocharger 28.

Engine system 10 also includes a fuel system 32. Fuel system 32 includes a fuel supply 34, one or more fuel pumps 36, and a fuel supply conduit 38 structured to convey pressurized fuel to a plurality of fuel injectors 40. Fuel injectors 40 are shown as port injectors each arranged to inject fuel into an intake port for a corresponding one of cylinders 16. Other embodiments contemplate direct injection, manifold injection, or fumigation admission of fuel into intake conduit 24. Fuel supply 34 might store fuel in a pressurized gaseous state or a cryogenically liquified state. Fuel supply 34 might also include so-called line gas from a pipe such as is available at a wellhead, a mine, a landfill, or as connected to gaseous fuel distribution infrastructure. In an implementation, engine system 10 thus operates on a gaseous fuel, such as natural gas, methane, ethane, or various blends including blends of gaseous hydrocarbon fuels and gaseous molecular hydrogen.

Engine system 10 also includes a control system 42 having an electronic control unit 44, including any suitable programmable logic unit having a processor and a memory, and a plurality of sensors. The plurality of sensors can include at least one engine sensor 46 which may be an engine temperature sensor, or an engine speed sensor, for example, and at least one additional sensor 48 structured to sense an exhaust temperature, for example, for purposes further discussed herein. Engine system 10 can be applied for any known purpose including operating a driveline in a vehicle, a compressor, or a pump. In one practical implementation strategy engine system 10 is used to operate an electric generator to generate electrical power.

Engine system 10 also includes an exhaust system 50. Exhaust system 50 includes a catalyst module 52 having a catalyst 54 therein. Catalyst 54 can be provided in the form of one more catalyst bricks or the like. Exhaust system 50 also includes an exhaust heater 56, and an exhaust recuperator 58 having a plurality of heat exchange surfaces 60 and 62. Exhaust conduit 64 conveys exhaust through turbine 30, through exhaust recuperator 58, through catalyst module 52, and then back through exhaust recuperator 58 to eventually discharge the exhaust by way of an exhaust outlet 65 such as a tailpipe or an exhaust stack. Exhaust recuperator 58 is structured to input heat energy to exhaust to improve catalyst efficiency as further discussed herein.

Catalyst module 52 includes a module inlet 66 arranged to receive a flow of incoming exhaust through recuperator 58, and a module outlet 68 arranged to feed a flow of outgoing exhaust through recuperator 58 to exchange heat with the flow of incoming exhaust via the plurality of heat exchange surfaces 60 and 62. “Incoming” refers to exhaust not yet catalytically treated. “Outgoing” refers to exhaust that has been catalytically treated. In an embodiment, the flow of incoming exhaust can be understood to impinge upon one or more first heat exchange surfaces 60 and be heated by the flow of outgoing exhaust impinging upon one or more second heat exchange surfaces 62, as further discussed herein.

Exhaust heater 56 is arranged to input heat energy to at least one of the flow of incoming exhaust or the flow of outgoing exhaust. In an implementation, exhaust heater 56 includes a fuel burner having a fuel admission valve 70. Fuel admission valve 70 can include any suitable flow control valve that controls a flow of a fuel, such as a gaseous fuel, into exhaust conduit 64. Fuel admission valve 70 can be electrically actuated, such as solenoid actuated, and controlled by way of electronic control unit 44. Also in a practical implementation, fuel admission valve 70 is fluidly connected to fuel supply conduit 38, thus to fuel supply 34. Accordingly, the fuel utilized by exhaust heater 56 may be the same fuel upon which engine 12 is operated. Engine 12 can be spark-ignited by way of a plurality of sparkplugs 41, although the present disclosure is not thereby limited and engine 12 could be prechamber-ignited, dual-fuel compression ignited utilizing a liquid pilot fuel and a gaseous main fuel, or ignited and operated by a range of other fuel types and/or fueling and ignition strategies.

Also in a practical implementation, engine system 10 may further include a blower 72 arranged to add air to a flow of exhaust through exhaust conduit 64 for combustion with fuel admitted by way of fuel admission valve 70. Depending upon the engine configuration and exhaust system arrangement, a blower might or might not be necessary. Blower 72 could include an electrically operated blower, or a blower supplied with a feed of pressurized air from compressor 26, for example. It has been observed that an amount of oxygen in exhaust may not always be sufficient for sustaining a stable combustion flame of fuel admitted into an exhaust stream, thus blower 72 can provide the additional air for combustion.

As discussed above, certain engines, notably engines operated on hydrocarbon fuels such as natural gas, may emit unburned methane in the exhaust stream. To reduce the amount of methane emitted, oxidation by way of a catalyst can be used. Thus, catalyst 54 may be an oxidation catalyst operable to promote oxidation of methane in exhaust from engine 12. In one implementation, the oxidation catalyst 54 includes a palladium catalyst. As will be further apparent from the following description, known palladium catalyst systems often operate at less than optimal efficiency, potentially only at about 20% efficiency. The present disclosure, utilizing recuperator 58 and exhaust heater 56 can assist in increasing or maintaining exhaust temperatures in a manner that increases catalyst efficiency.

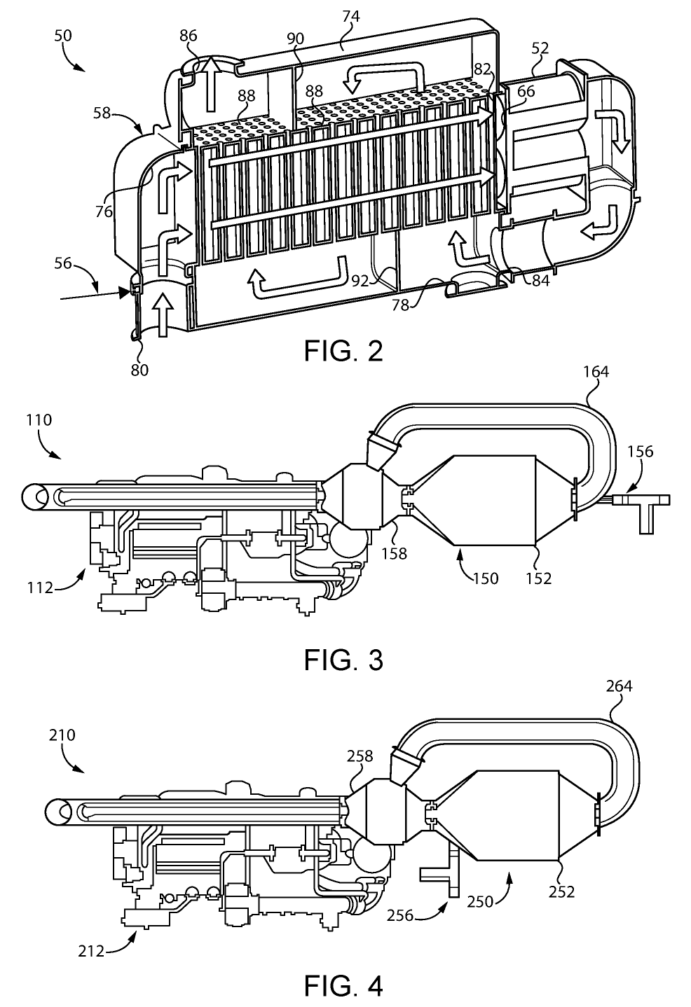

Referring also now to FIG. 2, there are shown features of exhaust system 50 in further detail. Recuperator 58 includes a housing 74 and forms an exhaust conduit incoming segment 76 and an exhaust conduit outgoing segment 78. Recuperator housing 74 also forms an inlet 80 arranged to receive a feed of raw exhaust from engine 12 and convey the same to outlet 82. Outlet 82 may fluidly connect to module inlet 66 to convey the feed of raw exhaust into catalyst module 52. “Raw” exhaust means exhaust that has not been catalytically treated. Exhaust that has been catalytically treated is conveyed from catalyst module 52 to another inlet 84 of recuperator housing 74. The now catalytically treated exhaust is conveyed into exhaust conduit outgoing segment 78. Exhaust conduit incoming segment 76 and exhaust conduit outgoing segment 78 are not fluidly connected but are in heat exchange communication by way of heat exchange surfaces as discussed herein.

In the illustrated example of FIG. 2 recuperator 58 includes a plurality of tubes 88 that convey the catalytically treated exhaust while the raw exhaust incoming passes over tubes 88. Exhaust flow through outgoing segment 78 is conveyed by way of another outlet 86 in recuperator housing 74 to exhaust outlet 65. Exhaust conduit 64 may thus be understood to include exhaust conduit incoming segment 76 and exhaust conduit outgoing segment 78, each formed at least in part by recuperator 58, and such that exhaust conduit outgoing segment 78 is arranged to feed catalytically treated exhaust in cross-flow heat exchange with exhaust conduit incoming segment 76. As noted, some example embodiments can include a plurality of tubes 88 in a cross-flow arrangement relative to the raw exhaust. A variety of other heat exchanger configurations are contemplated herein including shell and tube and still others. In a practical implementation, recuperator 58 includes a primary surface heat exchanger.

In FIG. 2, exhaust heater 56 is shown coupled to exhaust conduit incoming segment 76 at a location upstream of catalyst module 52, and upstream of recuperator 58 itself. In this arrangement, heating of the exhaust flowing in a downstream direction from engine 12 increases the exhaust temperature in advance of reaching catalyst module 52. An exothermic reaction in catalyst module 52, for example, oxidation of methane, results in the catalytically treated exhaust having a still higher temperature. Some of the heat energy of the catalytically treated exhaust is thus exchanged with the incoming exhaust in recuperator 58 further increasing the temperature of the incoming flow of exhaust. Other arrangements are contemplated herein, however, as discussed further below.

FIG. 3 shows an engine system 110 according to another embodiment, and including an engine 112 and an exhaust system 150. Exhaust system 150 includes a catalyst module 152, a recuperator 158, and an exhaust conduit 164. Exhaust system 150 also includes an exhaust heater 156 that may include a fuel burner and a blower. In the FIG. 3 embodiment, exhaust heater 156 is coupled to exhaust conduit 164 downstream of recuperator 158 and upstream of catalyst module 152.

FIG. 4 shows another engine system 210 including an engine 212, an exhaust system 250 having a catalyst module 252, a recuperator 258, and an exhaust conduit 264. Exhaust system 250 also includes an exhaust heater 256. Exhaust heater 256 is coupled to exhaust conduit 264 at a location that is downstream of catalyst module 252 and upstream of recuperator 258.

In each of the examples depicted in FIGS. 2, 3 and 4 it will be appreciated that a flow of exhaust that is not yet catalytically treated enters into the respective recuperator 58,158, 258, and flows by way of the respective conduit 64, 164, 264, to the respective catalyst module 52, 152, 252, and then back through the respective recuperator 58,158, 258. In view of the present description it will be appreciated that additional heat inputted to exhaust can occur at several different locations and still achieve the desired effect. In the FIG. 2 embodiment the exhaust is additionally heated prior to first flowing through recuperator 58. In the FIG. 3 embodiment the exhaust is additionally heated after first flowing through recuperator 158 and prior to flowing through catalyst module 152. In the FIG. 4 embodiment the exhaust is additionally heated after having flowed through catalyst module 252 and before flowing through recuperator 258 again. Each of these strategies and potentially still others provide additional heat input that promotes catalytic treatment of exhaust with improved efficiency.

### INDUSTRIAL APPLICABILITY

Returning to the embodiment of FIG. 1, but referring to all embodiments of the present disclosure generally, operating engine system 10 can include combusting a fuel such as a gaseous fuel in plurality of cylinders 16 in engine 12 to produce exhaust. Operating engine system 10 further includes feeding an incoming flow of exhaust through recuperator 58 to catalyst 54 in catalyst module 52. As discussed herein, catalytic treatment of the exhaust can result in oxidation of methane to carbon dioxide and water.

Operating engine system 10 also includes exchanging heat in recuperator 58 between the incoming flow of exhaust and the outgoing flow of exhaust. Additional heat energy is inputted to at least one of the incoming flow of exhaust or the outgoing flow of exhaust so as to increase the temperature of the incoming flow of exhaust fed to catalyst 54. Combustion of the admitted fuel by way of exhaust heater 56 causes the desired increase in temperature. As discussed herein the combustion may be enabled and/or supplemented by the addition of air into the flow of exhaust.

In some embodiments, operation of exhaust heater 56 may occur during a startup mode of engine system 10, and inputting of additional heat energy may be reduced or stopped when engine system 10 is transitioned from the startup mode to a running mode. Thus, when engine system 10 is first started and is relatively cold, it may be desirable to provide additional heat input to the exhaust to optimize efficiency of catalyst 54. When engine system 10 has reached a desired operating temperature, typically indicated by way of exhaust temperature monitoring via temperature sensor 48, additional heat input to the exhaust may not be necessary. Without being bound by theory, the exothermic operation of catalyst 54 may provide enough additional heat that optimum catalyst operating temperatures can be maintained without additional head input.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. An engine system comprising:
an engine including an engine housing having a plurality of cylinders formed therein;
an exhaust system including a catalyst module, an exhaust heater, and an exhaust recuperator having a first recuperator inlet, a second recuperator inlet, and a plurality of heat exchange surfaces;
the catalyst module having a module inlet arranged to receive a flow of incoming exhaust fed to the first recuperator inlet and then into and through the recuperator, and a module outlet arranged to feed a flow of outgoing exhaust to the second recuperator inlet and then into and through the recuperator to exchange heat with the flow of incoming exhaust via the plurality of heat exchange surfaces; and
the exhaust heater is arranged to input heat energy to at least one of the flow of incoming exhaust being fed to the first recuperator inlet or the flow of outgoing exhaust being fed to the second recuperator inlet.

2. The engine system of claim 1 wherein the exhaust heater includes a fuel burner having a fuel admission valve.

3. The engine system of claim 2 wherein the engine system includes a gaseous fuel engine system having a gaseous fuel supply, and the fuel admission valve includes a gaseous fuel admission valve coupled to the gaseous fuel supply.

4. The engine system of claim 2 further comprising a blower arranged to add air to the exhaust for combustion with fuel admitted via the fuel admission valve.

5. The engine system of claim 1 wherein the catalyst module includes an oxidation catalyst.

6. The engine system of claim 5 wherein the catalyst includes a palladium catalyst.

7. The engine system of claim 1 wherein the recuperator includes a primary surface heat exchanger.

8. The engine system of claim 1 wherein the exhaust system further includes an exhaust conduit having an incoming segment formed in part by the recuperator and arranged to feed raw exhaust from the engine, and an outgoing segment formed in part by the recuperator and arranged to feed catalytically treated exhaust in cross-flow heat exchange with the incoming segment.

9. The engine system of claim 8 wherein the exhaust heater is coupled to the incoming segment of the exhaust conduit at a location upstream of the catalyst module.

10. The engine system of claim 8 wherein the exhaust heater is coupled to the outgoing segment of the exhaust conduit at a location downstream of the catalyst module.

11. An exhaust system for an engine comprising:
a recuperator forming an exhaust conduit incoming segment and an exhaust conduit outgoing segment, and including a first recuperator inlet, a second recuperator inlet, and a plurality of heat exchange surfaces;
a catalyst module having a module inlet arranged to receive a flow of incoming exhaust fed to the first recuperator inlet and then into and through the recuperator, and a module outlet arranged to feed the flow of outgoing exhaust to the second recuperator inlet and then into and through the recuperator to exchange heat with the flow of incoming exhaust via the plurality of heat exchange surfaces; and
an exhaust heater arranged to input heat energy to at least one of the flow of incoming exhaust being fed to the first recuperator inlet or the flow of outgoing exhaust being fed to the second recuperator inlet.

12. The exhaust system of claim 11 wherein the exhaust heater includes a fuel burner having a fuel admission valve.

13. The exhaust system of claim 12 wherein the exhaust heater is arranged at a location upstream of the catalyst module to input heat energy to the flow of incoming exhaust.

14. The exhaust system of claim 12 wherein the exhaust heater is arranged at a location downstream of the catalyst module to input heat energy to the flow of outgoing exhaust.

15. The exhaust system of claim 11 wherein the catalyst module includes a palladium catalyst.

16. A method of operating an engine system comprising:
combusting a fuel in a plurality of cylinders in an engine to produce exhaust;
feeding an incoming flow of exhaust to a first inlet of a recuperator and then into and through the recuperator to a catalyst;
feeding an outgoing flow of exhaust from the catalyst to a second inlet of the recuperator and then into and through the recuperator;
exchanging heat in the recuperator between the incoming flow of exhaust and the outgoing flow of exhaust; and
inputting additional heat energy to at least one of the incoming flow of exhaust being fed to the first inlet of the recuperator or the outgoing flow of exhaust being fed to the second inlet of the recuperator so as to increase a temperature of the incoming flow of the exhaust fed to the catalyst.

17. The method of claim 16 further comprising:
admitting a gaseous fuel into at least one of the incoming flow of exhaust or the outgoing flow of exhaust for combustion to generate the additional heat energy; and
increasing an efficiency of the catalyst promoting oxidation of a constituent of the exhaust via the inputting additional heat energy.

18. The method of claim 17 further comprising adding air into at least one of the incoming flow of exhaust or the outgoing flow of exhaust for combustion with the admitted gaseous fuel.

19. The method of claim 16 further comprising promoting oxidation of methane in the exhaust via the catalyst.

20. The method of claim 16 wherein the inputting additional heat energy includes inputting additional heat energy in a startup mode of the engine system, and further comprising reducing or stopping the inputting additional heat energy in a running mode of the engine system.
